(19) United States
(12) Patent Application Publication
(10) Pub. No.: US 2025/0119054 A1
(43) Pub. Date: Apr. 10, 2025

(54) OPTIMIZED START-UP SCHEME FOR ISOLATED CASCADED AC/DC POWER CONVERTERS

(71) Applicant: Eaton Intelligent Power Limited, Dublin (IE)

(72) Inventors: Garry Jean-Pierre, Milwaukee, WI (US); Vijay Bhavaraju, Arvada, CO (US); Awneesh Kumar Tripathi, Waukesha, WI (US); Vasishta Burugula, Raleigh, NC (US)

(21) Appl. No.: 18/984,579

(22) Filed: Dec. 17, 2024

Related U.S. Application Data
(63) Continuation of application No. PCT/EP2023/025305, filed on Jun. 30, 2023.
(60) Provisional application No. 63/357,325, filed on Jun. 30, 2022.

(51) Int. Cl. H02M 1/36; H02M 1/00; H02M 1/32; H02M 3/335; H02M 7/81

(52) U.S. Cl. CPC H02M 1/36; H02M 1/007; H02M 1/0074; H02M 1/32; H02M 3/33573; H02M 3/33584; H02M 7/81

(57) ABSTRACT

In one embodiment, a method includes receiving DC bus voltage conditions of multiple AC to DC converters of an Input-Series-Output-Parallel power converter during a rectification stage; detecting a peak voltage of each of the DC bus of the multiple AC to DC converters has reached a first threshold voltage, and a Phase Loop Lock locked signal; upon detecting that the PLL locked signal, enabling a first voltage regulation to charge an AC to DC output of each of the multiple AC to DC converters to reach a first reference voltage; determining operating conditions including a load condition and an output voltage condition of multiple Dual Active Bridge (DAB) converters, and a monitored voltage of each of the multiple AC to DC converters; enabling a second voltage regulation of each of the multiple DAB converters to charge a DAB output to reach a second reference voltage based on the operating condition.

### PRIORITY

This application claims the benefit under 35 U.S.C. § 365(c) of International Patent Application No. PCT/EP2023/025305, filed 30 Jun. 2023, which claims the benefit under 35 U.S.C. § 119(e) of U.S. Provisional Patent Application No. 63/357,325, filed 30 Jun. 2022, which is incorporated herein by reference.

### STATEMENT REGARDING FEDERALLY SPONSORED RESEARCH OR DEVELOPMENT

This invention was made with government support under DE-EE0008448 awarded by the U.S. Department of Energy. The government has certain rights in the invention.

### TECHNICAL FIELD

This disclosure generally relates to power converters, and in particular relates to cascaded, multi-phase, power converters regulation.

### BACKGROUND

In light of the growing prevalence of DC loads and sources, the efficiency, control, and protection of medium voltage three-phase distribution systems (such as those based on 50/60 Hz and operating at 11/13 kV) and high-power, isolated DC conversion pose considerable challenges. Notably, the distribution of power to large-scale data centers and emerging Electric Vehicle (EV) DC fast-charging stations exemplifies the demand for DC loads. Solar photovoltaic (PV) and battery energy storage are typical DC sources that need to be connected and converted directly to the medium voltage (MV) power grid. In this context, a modular and isolated cascaded power converter employing an input series and output parallel (ISOP) configuration is increasingly recognized as the optimal solution using currently available power devices. The ISOP configuration offers several benefits, including enhanced control flexibility for integrating DC sources and loads, a smaller physical footprint, and higher efficiency. Such topology with a high-frequency transformer for isolation is commonly referred to as a solid-state transformer (SST).

The SST topology includes a set of series connected active front end (AFE) converters responsible for rectifying the input AC power to DC, and a set of parallel connected isolated dual active bridges (DAB) for generating the output DC power. When pre-charging the SST's AFE capacitors from the medium voltage (MV) grid, a pre-charge resistance circuit effectively limits the inrush current and charges the series connected AFEs. However, when charging the output capacitors and supplying power to connected loads, it becomes essential to limit peak current to safeguard the devices, balance the AFE dc voltages to not exceed the power device ratings and capacitor voltage, and prevent saturation of the transformer cores. This precaution is crucial since the dual active bridge (DAB) operation is necessary for the AFEs to share the input voltage in a cascaded configuration.

### SUMMARY OF PARTICULAR EMBODIMENTS

This disclosure presents a comprehensive pre-charge and start-up process for charging the cascaded AFE DC links as well as the output DC link capacitors of a cascade H-bridge based SST. This disclosure presents a phase shift control method for the DABs and system controls for the AFE and DAB to (a) limit the inrush currents, (b) avoid unequal sharing of voltage between AFEs, (c) avoid saturation of transformer cores, by controlled parallel charging of output converters with cascaded input converters, and smoothly charge the AFE and DAB capacitors under (a) no-load on output, (b) partial-load conditions during start-up, (c) without any voltage on the output DC bus capacitor, (d) with partial voltage on the output DC bus capacitor.

In particular embodiments, one or more computing systems may receive DC bus voltage conditions of a plurality of AC to DC converter converters of an ISOP power converter during a rectification stage for pre-charging DC bus of the plurality of AC to DC converters. The AC to DC converters may be single-phase or multi-phase AC to DC converter. In particular embodiments, the plurality of AC to DC converters may be a plurality of AFE converters connected in series. The ISOP power converter may be bi-directional that may be used for both AC to DC charging from an AC input side to a DC load side and DC to AC charging from the DC load side to the AC input side. The one or more computing systems may detect a peak voltage of each of the DC bus of the plurality of AC to DC converters during the rectification stage has reached a first threshold voltage, and that a Phase Loop Lock (PLL) signal indicates a locked state with an AC gird voltage. Upon detecting that the PLL signal indicates the locked state with the AC gird voltage, the one or more computing systems may enable a first voltage regulation to charge AC to DC output of each of the plurality of AC to DC converters to reach a first reference voltage. The one or more computing systems may determine an operating condition of the ISOP power converter. The operating condition may comprise a load condition and an output voltage condition associated with a plurality of DAB converters, and a monitored voltage condition of each of the plurality of AC to DC converters. The DAB converters may be implemented as isolated resonant converters. The one or more computing systems may enable a second voltage regulation of each of the plurality of DAB converters to charge a DAB output to reach a second reference voltage within a current limit based on the operating condition. The one or more computing systems may maintain the second reference voltage for the output voltage condition. The load condition may comprise a no-load condition and a partial load condition. The output voltage condition may comprise a zero-output voltage condition and a partial output voltage condition. The one or more computing systems may monitor an initial voltage value associated with the partial output voltage condition. The monitored voltage condition of each of the plurality of AC to DC converters may comprise the monitored voltage condition of the AC to DC output of each of the plurality of AC to DC converters has reached the first reference voltage, and the monitored voltage condition of the AC to DC output of each of the plurality of AC to DC converters has reached the peak voltage while the PLL signal indicates the locked state with the AC gird voltage. The one or more computing systems may simultaneously enable the second voltage regulation of each of the plurality of DAB converters to charge the DAB output to reach the second reference voltage when detecting the monitored voltage condition of each of the plurality of AC to DC converters has reached the first reference voltage. Additionally, or alternatively, the one or more computing systems may simultaneously enable the second voltage regulation of each of the plurality of DAB converters to charge the DAB AC to DC to reach the second reference voltage when detecting the monitored voltage condition of each of the plurality of AC to DC converters has reached the peak voltage while the PLL signal indicates the locked state with the AC gird voltage and the AC to DC output DC voltage is being regulated to a reference voltage.

In particular embodiments, the one or more computing systems may generate control variables for the second voltage regulation based on the operation condition, wherein the control variables comprise a first pulse width of a primary H-Bridge output voltage for each of the DAB converters, a second pulse width of a secondary H-Bridge output voltage for each of the DAB converters, and a phase shift angle between the primary H-Bridge output voltage and the secondary H-Bridge output voltage. The one or more computing systems may enable the second voltage regulation of each of the plurality of DAB converters to reach the second reference voltage within the current limit based on the control variables. The one or more computing systems may further pre-charge the DC bus of the plurality of AC to DC converters with a power source connected to an output of the DAB converters. The one or more computing systems may enable a reverse charging voltage regulation of each of the plurality of AC to DC converters being within the current limit based on the control variables.

In particular embodiments, maintaining the second reference voltage for the output voltage condition may comprise at least one of enabling an AC to DC output voltage regulation, or enabling a DAB DC voltage regulation. In particular embodiments, the rectification stage for pre-charging DC bus of the plurality of AC to DC converters may be enabled via a pre-charge switch system. The pre-change switch system may comprise a first switch and a resistor for reducing an inrush current, and a second bypass switch that operates when the peak voltage of each of the DC bus of plurality of AC to DC converters during the rectification stage has reached the first threshold voltage.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

Embodiments in accordance with this disclosure will now be described by reference to the accompanying drawings, in which:

FIG. 1 illustrates an example single-phase configuration of an AC/DC power converter system with N levels.

FIG. 2 illustrates an example flow diagram of a soft-start method for charging DC bus of the AC/DC power converter system.

FIG. 3 illustrates an example timing diagram for start-up scenarios of the AC/DC power converter system.

FIG. 4A illustrates an example flow diagram of a controller architecture for managing the soft-start charging for one single-phase of the AC/DC power converter system.

FIG. 4B illustrates an example flow diagram of a controller architecture for managing the soft-start charging for the DAB converter.

FIG. 5 illustrates an example timing diagram of DAB AC voltage and inductor current when the primary and secondary duty cycles are used in addition to the phase angle.

FIG. 6 illustrates an example three-phase AC/DC power converter system configuration.

FIG. 7 illustrates an example computer system.

### DESCRIPTION OF EXAMPLE EMBODIMENTS

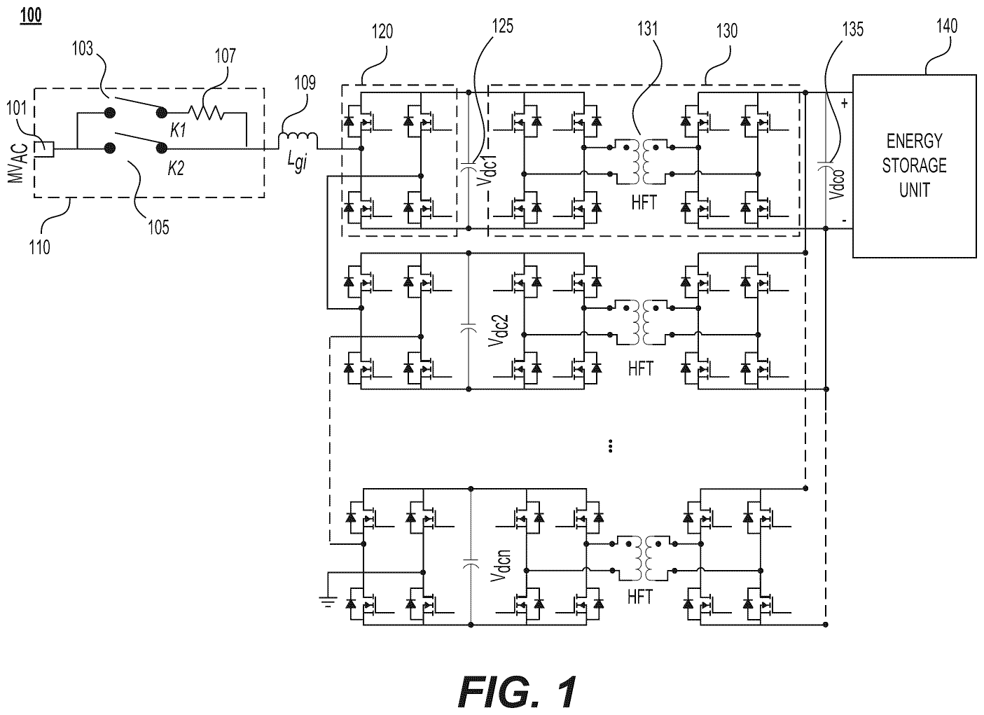

FIG. 1 illustrates an example single-phase configuration of an AC/DC power converter system with N levels. The AC/DC power converter system 100 may comprise an ISOP converter with cascaded H-bridge based SST. The AC/DC power converter system 100 may comprise a pre-charge switch system 110. The pre-charge connector may comprise a first switch 103 and a second switch 105 parallel connected with the first switch 103, and the first switch 103 may also be connected to a pre-charging resistor 107 in series. A charging current may be limited by the pre-charging resistor 107. The AC/DC power converter system may further comprise an inductor 109 to limit the inrush in charging current so that the AC/DC power converter system 100 capacitors may be charged slowly. The pre-charge switch system may be connected to an AC source 101, where an AC input may be first converted to DC using an Active Front End (AFE) converter 120. The AFE converter may actively control the power flow from the AC source 101. The AC/DC power converter system 100 may incorporate switching devices, such as Insulated Gate Bipolar Transistors (IGBTs) or MOSFETs, to enable precise control of the input current waveform. The AFE converter 120 may allow bidirectional power flow, which may be used for situations that require both AC-DC and DC-AC power conversion. In the configuration as shown in FIG. 1, the AC input may be first converted to inner DC through an AC-DC rectifier stage using the AFE converter 120. The AC/DC power converter system 100 may comprise a series of N AFE converters for rectification. The DC output at the capacitor 125 from the AFE converter 120 may then be connected to N DC-DC converters arranged in parallel, where N may depend on the input AC voltage. The SST may be used for lower voltage applications and may not restricted to medium voltage. Such configuration may be the Dual Active Bridge (DAB) converter 130 with high frequency transformer (HFT) 131 in each level. The DAB may be employed in the DC-DC conversion stage of the circuit and creates a DAB DC output at the capacitor 135. The output DC may be connected to an energy storage unit 140.

The two-stage multilevel ISOP structure may be able to meet the requirements of connecting to MV AC using the currently widely available power MOSFETs and such structure may provide galvanic isolation between the load and the input source. Additionally, the two-stage multilevel ISOP structure may achieve bidirectional power flow and scalability to meet different power and voltage levels. The multilevel topology as shown in FIG. 1 may allow the use of low blocking voltage switching devices with low on-state resistance, which may result in decreased conduction losses and the ability to operate at a higher switching frequency. The multilevel configuration may be useful in decreasing the current and voltage harmonics, which may directly result in the use of smaller filter components, thus reducing the system footprint. To meet the AC voltage requirements, a modular structure for multilevel systems may be achieved through the series cascading of multiple modules. As the system may be scaled for different voltage levels and power ratings, the modular structure for multilevel systems may be more manageable in the case of a module failure. Moreover, one of the main requirements for MV AC-DC systems may be the integration of galvanic isolation between the AC grid and the DC-side loads, which may be achieved by the ISOP DAB converters.

Conventional start-up procedure for limiting the inrush current during start-up includes using zero voltage switching (ZVS) for an SST system. While achieving ZVS can limit the inrush current during start-up, the SST based system contains an additional switch and passive components at the front-end stage and uses auxiliary power supply in the implemented start-up scheme, resulting in an increased system size. Additionally, conventional start-up procedure may include using a stage-by-stage start-up method which may leads to increased leakage current, pre-charging the AC-DC and DC-DC stages simultaneously, adding additional DC-DC converter to the SST system to facilitate the pre-charge of the LV DC link stage, and using auxiliary power units (APU) for pre-charging. However, load conditions may impact inrush currents during pre-charging of the DC bus capacitors for the solid-state transformer (SST). The magnitude of the load, reactive load components, switching dynamics, and load variations can all influence the behavior of inrush current. Robust control strategies are crucial to manage inrush current and ensure optimal SST performance under varying load conditions.

According to the SST configuration as shown in FIG. 1, the disclosure presents a soft-start procedure for the modular two-stage SST energized from either the MV AC end or the LV DC end. The DC-DC converter stage is used to perform the crucial role in pre-charging either the MV DC link or LV DC link and mitigating the inrush overcurrent issue of the HFT. The soft-start method may eliminate the need for the APU for limiting the inrush current.

In particular embodiments, the soft-start charging for DC bus of the AC/DC power converter system 100 may be a two-step procedure. The first step may start with connecting the AC-DC converter (e.g., AFE converter 120) to the AC source 101. The MV DC link of the DC output at the capacitor 125 may be energized via the pre-charging resistor 107 and inductor 109 to reduce the inrush current. The LV DC-link of DAB DC output at the capacitor 135 pre-charging may be a crucial condition to start the regulation of the DAB converter 130, while the regulated MV DC link of the DC output at the capacitor 125 is feeding the input port of the DAB stage. Uncharged LV capacitors may act as short circuits, which may allow a rapid increase of the leakage current that can surpass the rated and safe operating limits of the devices.

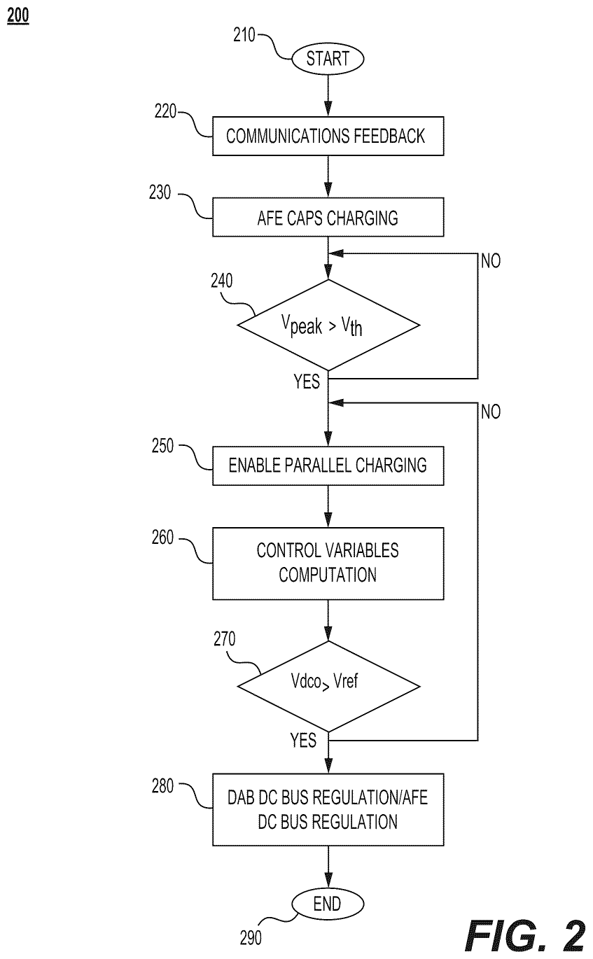

FIG. 2 illustrates an example flow diagram of a soft-start method for charging DC bus of the AC/DC power converter system. In particular embodiments, one or more computing systems may start the soft-start method for charging DC bus of the AC/DC power converter system at step 210. At step 220, the one or more computing systems may receive communication feedback associated with the status of the AC/DC power converter system. In particular embodiments, the communication feedback may comprise one or more of indications for all gate drive power supply are health, an availability of the AC/DC power converter system grid, indications for no-faults in the system after a reset signal is sent, indications that controllers reports healthy communications, indications that a protection relay communication for the AC/DC power converter system grid is correct, a pre-charge control is ready to run, or indications for receiving a Phase Loop Lock (PLL) locked signal. At step 230, once the one or more computing system has checked the communication feedback such as the input voltage waveform from AC source 101 is within the desired parameters and is suitable for the proper operation of the AC/DC power converter system 100 and the PLL is locked, the one or more computing systems may start pre-charge the DC output at the capacitor 125 for output at the N AFE converters, and the DC bus link of the DAB DC output at the capacitor 135. At step 230, the first switch 103 may be closed and the second switch may remain open. Once pre-charging starts, the one or more computing systems may keep receiving DC bus voltage conditions of each AFE converter, such as DC bus voltage V_{dc1} at capacitor 125 for the N levels of the AC/DC power converter system 100. At step 240, the one or more computing systems may determine if a peak voltage of each of the DC bus of the N AFE converters V_{dc1}, V_{dc2}, . . . and V_{dcn} during a rectification stage has reached a first threshold voltage. The one or more computing systems may further regulate the DC bus voltages V_{dc1}, V_{dc2}, . . . and V_{dcn} until V_{dc1}, V_{dc2}, . . . and V_{dcn} have reached a reference voltage of a steady state upon detecting the PLL locked signal. At step 250, once all the voltages at the capacitors, such as capacitor 125, for the N AFE converters have reached the first threshold voltage, the one or more computing systems may enable parallel charging the DAB DC output at the capacitor 135 through the DAB converters and may start the regulation of the DAB converters.

In particular embodiments, the one or more computing systems may determine an operating condition of the AC/DC power converter system 100 for parallel charging. The operating condition of the AC/DC power converter system 100 may comprise a load condition, an output voltage condition V_{dcO} associated with the DAB converters, and a monitored voltage condition V_{dc1}, V_{dc2}, . . . and V_{dcn} of the each of the N AFE converters. At step 260, the computing system may regulate the output voltage V_{dcO} and limit the inrush overcurrent of the HFT when charging the DAB converter based on the operating condition of the AC/DC power converter system 100. In particular embodiments, the computing system may calculate control variables based on the operation condition. The control variables may comprise a first pulse width D1 of a primary H-Bridge output voltage for each of the DAB converters, a second pulse width D2 of a secondary H-Bridge output voltage for each of the DAB converters, and a phase shift angle φ between the primary H-Bridge output voltage and the secondary H-Bridge output voltage. The one or more computing systems may constantly adjust the control parameters so that the DC output voltage may raise at a constant rate until reaching a steady state for the DC output voltage V_{dcO} at the capacitor 135. The one or more computing systems may continue monitoring the DC output voltage V_{dcO} at the capacitor 135 that is converted by DAB, and maintain the steady state. At step 270, the one or more computing systems may determine the DC output voltage V_{dcO} has reached a second reference voltage. At step 280, to maintain the steady state and to limit the inrush overcurrent of the HFT, the one or more computing systems may enable at least one of the AFE DC bus regulation, or the DAB bus regulation. The soft-start procedure may end at step 290 when the AFE inner DC link V_{dc1}, V_{dc2}, . . . and V_{dcn} and the DAB output DC link V_{dcO} have maintained their steady state.

In particular embodiments, the operating condition of the AC/DC power converter system 100 may comprise a load condition, an output voltage condition associated with the parallel connected DAB converters, and a monitored voltage condition of each of the plurality of AFE converters. In particular embodiments, the load condition may comprise a no-load condition and a partial load condition. The load may be connected to the DAB output. In particular embodiments, the output voltage condition associated with the parallel connected DAB converters may be zero when the DAB converter initially begins to ramp up. Additionally or alternatively, the initial voltage for the output voltage condition associated with the parallel connected DAB converters may be greater than zero. As an example not by way of limitation, there may be a glitch when the AFE inner bus link voltages V_{dc1}, V_{dc2}, . . . and V_{dcn} and the DAB output DC link V_{dcO} are regulated. When the glitch happens, the capacitors for AFE and DAB, such as capacitors 125 and 135 may discharge, which may lead to a greater than zero voltage level at the DAB output DC link V_{dcO}. The monitored voltage condition of each of the N AFE converters V_{dc1}, V_{dc2}, . . . and V_{dcn} may comprise a first condition where the inner bus link voltages V_{dc1}, V_{dc2}, . . . and V_{dcn} have reached the peak voltage while PLL locked. Additionally or alternatively, The monitored voltage condition of each of the N AFE converters V_{dc1}, V_{dc2}, . . . and V_{dcn} may comprise a first condition where the inner bus link voltages V_{dc1}, V_{dc2}, . . . and V_{dcn} have reached the first reference voltage for a steady state. The one or more computing systems may start pre-charging the DAB output DC link V_{dcO} based on the load condition applied to V_{dcO} at capacitor 135, the AFE inner DC link V_{dc1}, V_{dc2}, . . . and V_{dcn} conditions, and the initial value of the DAB output DC link V_{dcO}.

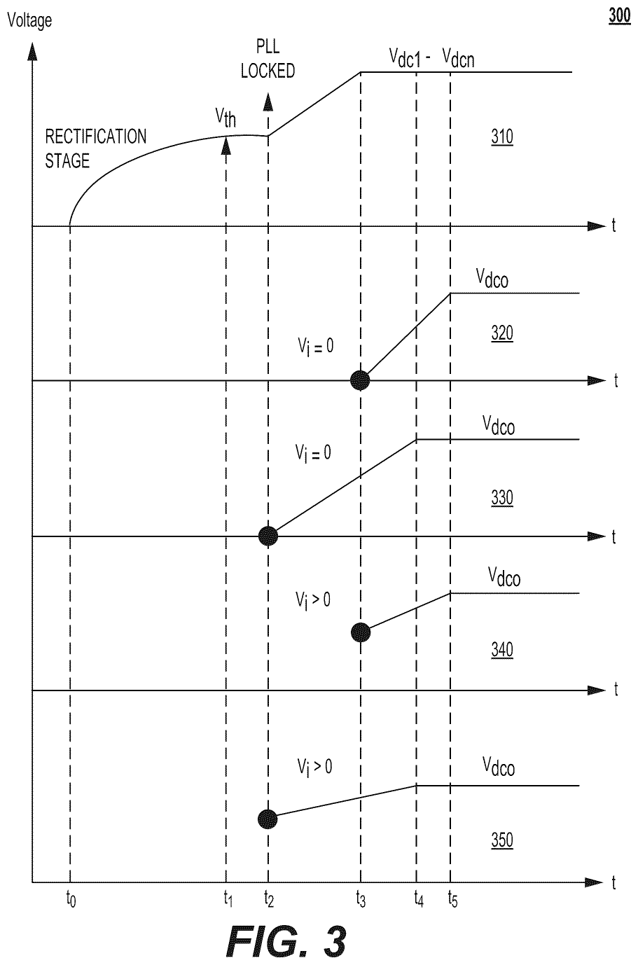

FIG. 3 illustrates an example timing diagram for start-up scenarios of the AC/DC power converter system. The AFE soft-start is shown by voltage-time plot 310. In particular embodiments, the AFE as a rectifier may first charge the inner DC bus via the body diodes of the MOSFETs as shown in FIG. 1. The charging resistor may be utilized to limit the charging current. The diode rectification state may be between t₀ and t₁. At t₁, the one or more computing systems may detect a peak voltage of each of the DC bus of the N AFE converters during the rectification stage has reached a first threshold voltage. At time t₂, the PLL is locked to the grid and the computing systems starts actively control the MV DC bus. At t₃, the desired inner DC link may be equal to a first reference voltage and the first stage of pre-charging the inner DC link via AFEs may be operating at a steady state.

In particular embodiments, the one or more computing systems may determine a first operating condition where there may be no load connected to the output of the DAB converter, the inner DC link V_{dc1}, V_{dc2}, . . . and V_{dcn} have reached the first reference voltage and their steady state, and an initial DAB output voltage at the DC bus is zero. The DAB soft-start is shown by plot 320. The one or more computing systems may enable the DAB soft-start when the inner DC link reaches its steady state operation at t₃, and may end the pre-charge of the DAB at t₅, when the output voltage V_{dcO} reaches a steady state.

In particular embodiments, the one or more computing systems may determine a second operating condition where there may be partial load connected to the output of the DAB converter, the inner DC link V_{dc1}, V_{dc2}, . . . and V_{dcn} have reached the first reference voltage and their steady state, and an initial DAB output voltage at the DC bus is zero. The DAB soft-start is shown by plot 320. The one or more computing systems may enable the DAB soft-start when the inner DC link reaches its steady state operation at t₃, and may end the pre-charge of the DAB at t₅, when the output voltage V_{dcO} reaches a steady state.

In particular embodiments, the one or more computing systems may determine a third operating condition where there may be no load connected to the output of the DAB converter, the inner DC link V_{dc1}, V_{dc2}, . . . and V_{dcn} have reached the peak voltage of the inner bus link associated with the AFE converters during the rectification stage, and an initial DAB output voltage at the DC bus is zero. The DAB soft-start is shown by plot 330. The one or more computing systems may enable the DAB soft-start when the inner DC link reaches the peak voltage and the PLL signal is detected at t₂, and may end the pre-charge of the DAB at t₄, when the output voltage V_{dcO} reaches a steady state. The inner DC link V_{dc1}, V_{dc2}, . . . and V_{dcn} may reach their steady state faster than the output DC V_{dcO}.

In particular embodiments, the one or more computing systems may determine a fourth operating condition where there may be partial load connected to the output of the DAB converter, the inner DC link V_{dc1}, V_{dc2}, . . . and V_{dcn} have reached the peak voltage of the inner bus link associated with the AFE converters during the rectification stage, and an initial DAB output voltage at the DC bus is zero. The DAB soft-start is shown by plot 330. The one or more computing systems may enable the DAB soft-start when the inner DC link reaches the peak voltage and the PLL signal is detected at t₂, and may end the pre-charge of the DAB at t₄, when the output voltage V_{dcO} reaches a steady state. The inner DC link V_{dc1}, V_{dc2}, . . . and V_{dcn} may reach their steady state faster than the output DC V_{dcO}.

In particular embodiments, the one or more computing systems may determine a fifth operating condition where there may be no load connected to the output of the DAB converter, the inner DC link V_{dc1}, V_{dc2}, . . . and V_{dcn} have reached the first reference voltage and their steady state, and an initial DAB output voltage at the DC bus is greater than zero. The DAB soft-start is shown by plot 340. The one or more computing systems may obtain the initial value of the DAB output voltage Vᵢ and enable the DAB soft-start when the inner DC link reaches its steady state operation at t₃, and may end the pre-charge of the DAB at t₅, when the output voltage V_{dcO} reaches a steady state.

In particular embodiments, the one or more computing systems may determine a sixth operating condition where there may be partial load connected to the output of the DAB converter, the inner DC link V_{dc1}, V_{dc2}, . . . and V_{dcn} have reached the first reference voltage and their steady state, and an initial DAB output voltage at the DC bus is greater than zero. The DAB soft-start is shown by plot 340. The one or more computing systems may obtain the initial value of the DAB output voltage Vᵢ and enable the DAB soft-start when the inner DC link reaches its steady state operation at t₃, and may end the pre-charge of the DAB at t₅, when the output voltage V_{dcO} reaches a steady state.

In particular embodiments, the one or more computing systems may determine a seventh operating condition where there may be no load connected to the output of the DAB converter, the inner DC link V_{dc1}, V_{dc2}, . . . and V_{dcn} have reached the peak voltage of the inner bus link associated with the AFE converters during the rectification stage, and an initial DAB output voltage at the DC bus is greater than zero. The DAB soft-start is shown by plot 350. The one or more computing systems may obtain the initial value of the DAB output voltage Vᵢ and enable the DAB soft-start when the inner DC link reaches the peak voltage and the PLL signal is detected at t₂, and may end the pre-charge of the DAB at t₄, when the output voltage V_{dcO} reaches a steady state. The inner DC link V_{dc1}, V_{dc2}, . . . and V_{dcn} may reach their steady state faster than the output DC V_{dcO}.

In particular embodiments, the one or more computing systems may determine an eighth operating condition where there may be partial load connected to the output of the DAB converter, the inner DC link V_{dc1}, V_{dc2}, . . . and V_{dcn} have reached the peak voltage of the inner bus link associated with the AFE converters during the rectification stage, and an initial DAB output voltage at the DC bus is greater than zero. The DAB soft-start is shown by plot 350. The one or more computing systems may obtain the initial value of the DAB output voltage Vᵢ and enable the DAB soft-start when the inner DC link reaches the peak voltage and the PLL signal is detected at t₂, and may end the pre-charge of the DAB at t₄, when the output voltage V_{dcO} reaches a steady state. The DAB converter may begin ramping up simultaneously with the AFE stage and reach the steady state value at t₄. The inner DC link V_{dc1}, V_{dc2}, . . . and V_{dcn} may reach their steady state faster than the output DC V_{dcO}. The soft-start control may maintain low inrush and peak current.

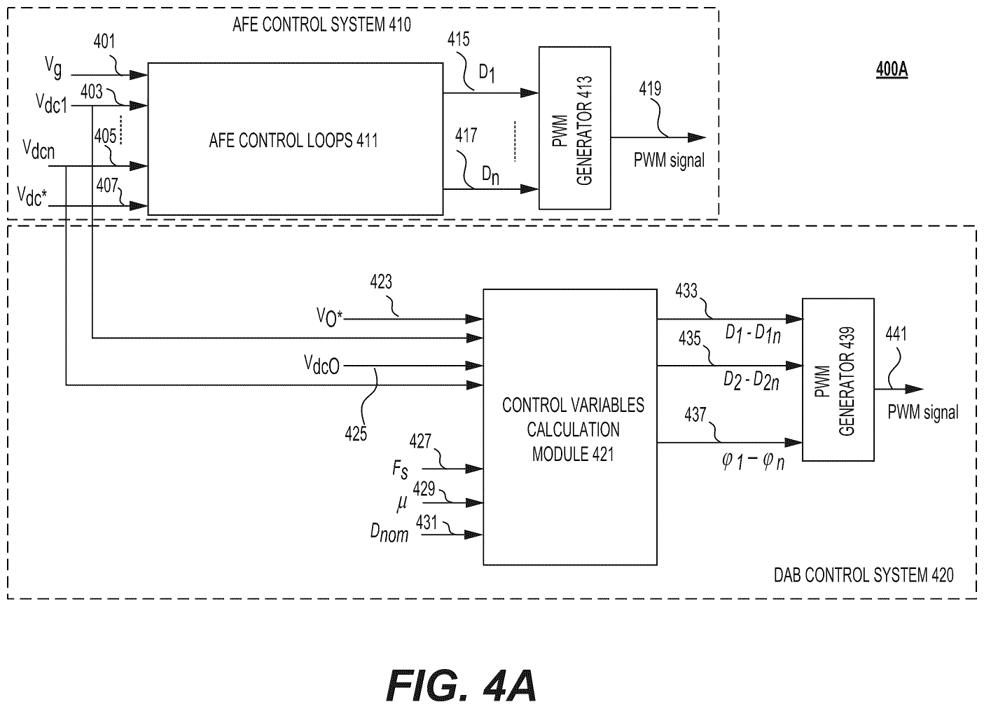

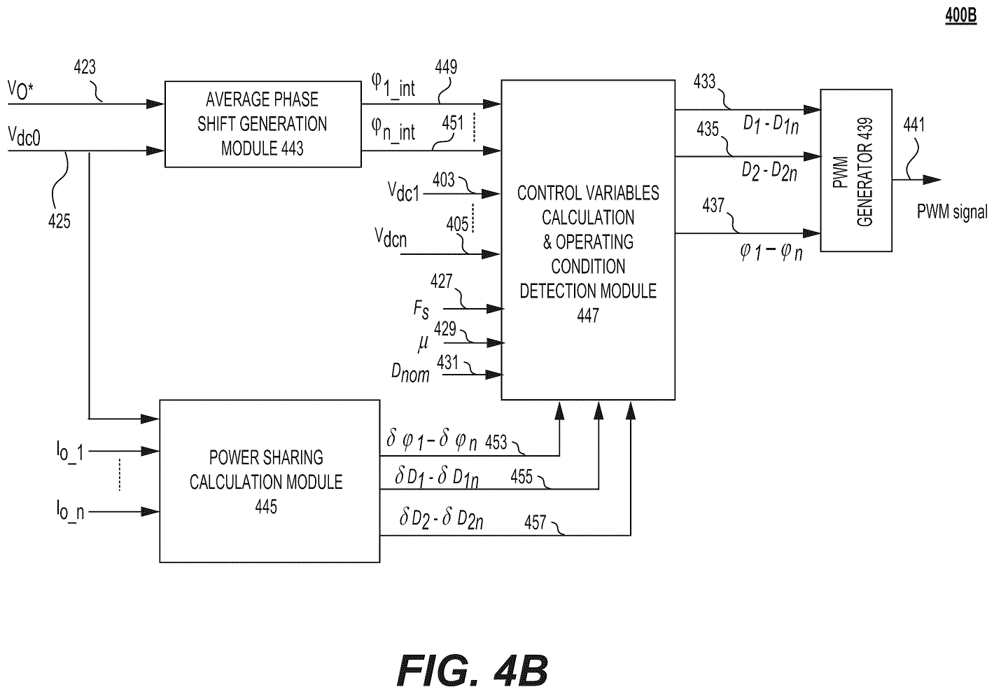

FIG. 4A illustrates an example flow diagram of a controller architecture for managing the soft-start charging for one single-phase of the AC/DC power converter system. The control system 400A for the one phase AC/DC power converter system 100 may comprise an AFE control subsystem 410 and a DAB control subsystem 420. An AFE control loops 411 may receive an AC grid voltage V_{g} 401, the monitored AFE inner DC bus link voltages V_{dc1}, V_{dc2}, . . . and V_{dcn} (403, . . . and 405), and a first reference voltage V_{dc}* 407 for the AFE inner bus link. The AFE control loops 411 may comprise one or more controllers for standard DQ control, SOGI PLL, and the cascaded specific voltage balancing control of AFE DC bus. The AFE control loops 411 may generate, for each AFE converter, duty cycle D₁, . . . . Dₙ (415, . . . 417). The AFE duty cycles may be received by a Pulse Width Modulation (PWM) generator, and the PWM generator may generate a corresponding first PWM signal 419 with the specified duty cycle. The monitored AFE inner DC bus link voltages V_{dc1}, V_{dc2}, . . . and V_{dcn} (403, . . . and 405) may be also provided to a control variable calculation and operating condition detection module 447 of the DAB control subsystem 420. The control variables calculation module 421 may also receive a second reference voltage V_{O}* 423 for the DAB output DC bus link, a monitored DC output voltage V_{dcO} 425, a switching frequency Fₛ 427 of the AC/DC power converter system 100, an allowable time to charge the DC capacitor μ 429, a saturated value of the duty cycle Dₙₒₘ 431. The control variables calculation module 421 may detect an operating condition of the AC/DC power converter system 100. The operating condition may comprise a load condition and an output voltage condition associated with the DAB converters, and a monitored voltage condition of each AFE converters. The operating condition may be one of the eight operating conditions as discussed above. The control variables calculation module 421 may generate control variables for each of the N levels of the AC/DC power converter system 100. The control variables calculation module 421 may generate a first pulse width D₁ of primary H-Bridge output voltage associated with the DAB converters, a second pulse width D₂ of secondary H-Bridge output voltage for each of the DAB converters, and a phase shift angle φ₁ between the primary H-Bridge output voltage and the secondary H-Bridge output voltage. The control variables calculation module 421 may generate D₁ₙ, D₂ₙ, and φₙ, for N levels of the AC/DC power converter system 100. The first pulse width [D₁, D₁₂, . . . . D₁ₙ] 433 or each DAB converter primary H-Bridge output voltage, the first pulse width [D₂, D₂₂, . . . . D₂ₙ] 435 for each DAB converter primary H-Bridge output voltage, and the phase shift angle [(φ₁, φ₂, . . . φₙ] 437 between each primary H-Bridge output voltage and the each secondary H-Bridge output voltage may be received by a PWM generator 439 of the DAB control subsystem 420. The PWM generator 439 may generate a second PWM signal 441 for precisely controlling and modulating power delivery to a load.

FIG. 4B illustrates an example flow diagram of a controller architecture for managing the soft-start charging for the DAB converter. In particular embodiments, the DAB control subsystem 420 may comprise an average phase shift generation module 443, a power sharing calculation module 445, and a control variables calculation and operating condition detection module 447. The average phase shift generation module 443 may receive the second reference voltage V_{O}* 423 for the DAB output DC bus link and the monitored DC output voltage V_{dcO} 425 and calculate the average initial phase angle φ_{1_int} 449, . . . and φ_{n_int} 451 for each DAB converter based on the second reference voltage V_{O}* 423 for the DAB output DC bus link and the monitored DC output voltage V_{dcO} 425. The power sharing calculation module 445 may calculate power mismatch and generate an augmented angle [δφ₁, δφ₂, . . . , δφₙ] 453 and duty ratios [δD₁, δD₁₂, . . . , δD₁ₙ] 455 and [δD₂, δD22, . . . , δD₂ₙ] 457 for each DAB converter based on the monitored DC output voltage V_{dcO} 425, and output current [I_{O_1}, I_{O_2}, . . . . I_{O_n}] associated with each DAB converter. The control variables calculation and operating condition detection module 447 may receive the average initial phase angle φ_{1_int} 449, . . . and φ_{n_int} 451 for each DAB converter, the augmented angle [δφ₁, δφ₁, . . . , δφₙ] 453 and duty ratios [δD₁, δD₁₂, . . . , δD₁ₙ] and [δD₂, δD22, . . . , δD₂ₙ] for each DAB converter, AFE inner DC bus link voltages V_{dc1}, V_{dc2}, . . . and V_{dcn} (403, . . . and 405), the switching frequency Fₛ 427 of the AC/DC power converter system 100, the allowable time to charge the DC capacitor μ 429, the saturated value of the duty cycle Dₙₒₘ 431, and the operating condition to determine the control variables for the DAB converters (e.g., first DAB converter 130) of the AC/DC power converter system 100.

In particular embodiments, the AFE control subsystem 410 may operate when the computing system detects a peak voltage of each of the DC bus of plurality of AFE converters during the rectification stage has reached a first threshold voltage, and a Phase Loop Lock (PLL) locked signal. For example, the AFE control subsystem 410 may start to operate at t₂ in the plot 310 as shown in FIG. 3. The DAB control subsystem 420 may operate when the DAB converters simultaneously start ramping up at t₂ as shown in plot 330 and plot 350, or at t₃ as shown in plot 320 and plot 340 in FIG. 3.

In particular embodiments, the AC/DC power converter system 100 may comprise a power source (e.g., a battery) instead of the energy storage unit 140 connected to the DC output at 135. The power source may reverse charge the AC/DC power converter system 100 from a load end of the AC/DC power converter system 100. During the reverse charging process, the DC output voltage maybe fed back to the AC input side, which may allow power to flow in the opposite direction when necessary to return power from the load side where the DAB DC output at the capacitor 135 is connected to the source side where the AC source 101 is connected. The one or more computing systems may adopt the DAB control subsystem 420 and the AFE control subsystem 410 to prevent excessive current from flowing in the AC/DC power converter system 100. The control system 400A for the one phase AC/DC power converter system 100 may detect a power flow detection for the phase shift angle.

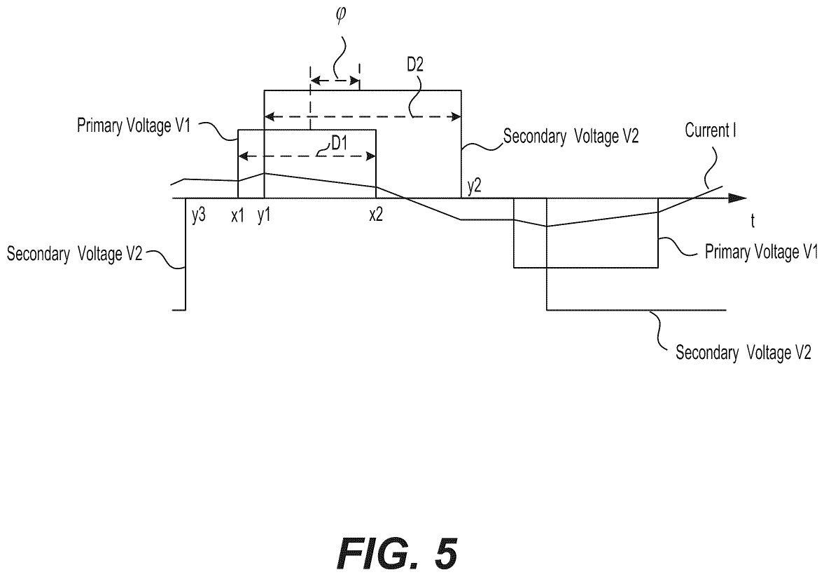

FIG. 5 illustrates an example timing diagram of DAB AC voltage and inductor current when the primary and secondary duty cycles are used in addition to the phase angle. As shown in FIG. 5, the rising and falling time of a primary voltage V1 for the primary H-bridge output voltage of the DAB may be denoted as x₁ and x₂. The rising and falling times of a secondary voltage V2 for the secondary H-bridge output voltage of the DAB may be denoted as y₁ and y₂. The rising up time from negative V2 may be denoted as y₃.

$${x}_{1} = 1 - {D}_{1} \qquad ( 1 a )$$

$${x}_{2} = 1 + {D}_{1} \qquad ( 1 b )$$

$${y}_{1} = 1 - {D}_{2} + φ \qquad ( 1 c )$$

$${y}_{2} = 1 + {D}_{2} + φ \qquad ( 1 d )$$

$${y}_{3} = - 1 + {D}_{2} + φ \qquad ( 1 e )$$

The instantaneous current is calculated piecewise for each region of operation based on:

$${I}_{l} ( t ) = {I}_{0} + \frac{1}{L} {\int }_{{Z}_{A}}^{{Z}_{B}} ( {V}_{1} ( t ) - {V}_{2} ( t ) ) d t \qquad ( 2 )$$

Z_{A} and Z_{B} may be 0, x1, x2, y1, y2, y3, or 2, depending on the region of operation and the piece of the current. The output current may not be vertically symmetrical. However, after the transient, the current is symmetric around the time axis. Therefore, the average of the current may be calculated and subtracted from the instantaneous current. The average current may be calculated in a piecewise manner:

$${I}_{a v e} = {\sum }_{( i = 1 )}^{8} {\int }_{{Z}_{{A}_{i}}}^{{Z}_{{B}_{i}}} I ( t ) dt \qquad ( 3 )$$

The average power may be calculated piecewise in each region, where V₁ and I are variables, depending on the piece in each region:

$${P}_{ave 1 - 5} = {\sum }_{( i = 1 )}^{8} {V}_{1} ( t ) {\int }_{Z A i}^{Z B i} ( I ( t ) - {I}_{a v e} ) d t \qquad ( 4 )$$

In particular embodiments, the power transfer for bidirectional pre-charge of DAB may be formulated by

$${P}_{1} = \frac{{V}_{dc 1} {V}_{d c o}}{8 L F} 2 {D}_{1} {D}_{2} \qquad ( 5 )$$

$${P}_{2} = \frac{{V}_{dc 1} {V}_{d c o}}{8 L F} 2 {D}_{2} φ \qquad ( 6 )$$

$${P}_{3} = \frac{{V}_{dc 1} {V}_{d c o}}{8 L F} 2 {D}_{1} φ \qquad ( 7 )$$

$${P}_{4} = \frac{{V}_{dc 1} {V}_{d c o}}{8 L F} ( \begin{matrix}- \frac{1}{2} {( {D}_{1} - {D}_{2} )}^{2} + \\ φ ( {D}_{1} + {D}_{2} - 1 / 2 φ )\end{matrix} ) \qquad ( 8 )$$

$${P}_{5} = \frac{{V}_{dc 1} {V}_{d c o}}{8 L F} ( \begin{matrix}- ( {D}_{1} + {D}_{2}^{2} ) - 2 + \\ 2 ( {D}_{1} + {D}_{2} ) + φ ( 2 - φ )\end{matrix} ) \qquad ( 9 )$$

The expression of the average powers after the common term of

$$\frac{{V}_{d c 1} {V}_{d c o}}{8 L F}$$

is the per-unit power. Controlling the duty cycles while maintaining the phase shift controller inactive may achieve pre-charge from either port of the AC/DC power converter system 100. In particular embodiments, the one or more computing systems may apply power constraints for the duty cycles:

$${P}_{1} = 0.5 at ( {D}_{1} = {D}_{2} = 0 \text{.5} ) \qquad ( 10 )$$

$${D}^{′} = {D}_{init} + \frac{{D}_{n o m} - {D}_{i n i t}}{μ {F}_{s}} \qquad ( 11 )$$

$${D}_{init} = \frac{{V}_{d {c}_{m}} μ + {V}_{d {c}_{m}} {V}_{d {c}_{r e f}}}{K {V}_{d {c}_{r e f}}} \qquad ( 12 )$$

Once either the MV or LV DC link is charged and regulated, the HFT 131 of the DAB converter 130 may be magnetized to pre-charge the desired DC bus. A switched three-level voltage with a gradually increasing duty-cycle is applied to both bridges of the DAB converter 130, which may impose a gradually increasing current in the HFT 131. To maintain symmetrical current of the HFT 131, the duty-cycles D1 and D2 are increased every two switching cycles. Once the converter start-up is enabled, both the primary and secondary side switches are turned on and the duty-cycles increase smoothly according to equation (11), where D′ is the desired start-up duty, Dᵢₙᵢₜ is the calculated initial duty. The Dᵢₙᵢₜ is important in determining at what duty the pre-charge needs to start. The computing system may determine at what duty the pre-charge needs to start based on the calculated initial duty Dᵢₙᵢₜ for operating conditions as shown in plot 340 and plot 350 of FIG. 3. The Dₙₒₘ is the saturated value of the duty cycle, K is a constant, and μ is the allowable time to charge the DC capacitor.

In particular embodiments, the AFE converter 120 and other AFEs in for the N levels of the AC/DC power converter system 100 may establish a connection with the MV AC grid and a MV DC link when the charging direction is MV to LV. The DAB converter 130 and other DABs in for the N levels of the AC/DC power converter system 100 may be used to accomplish the bidirectional operation. The AFE converters may be first synced to the MV AC grid. In particular embodiments, the first pulse width D1 of the primary H-Bridge output voltage for the DAB converter may be used to slowly bring the primary side AC voltage of the HFT to full square wave, and the second pulse width D2 of the secondary H-Bridge output voltage for the DAB converter may be used to slowly ramp up the voltage of the secondary side of the HFT to the second reference value. When both sides reach the desired voltage ratio, a phase shift controller may be enabled to start the steady state operation. The multilevel soft-start charging method may prevent the saturation of the HFT through the reduction of inrush current.

In particular embodiments, the LV DC link is used to pre-charge and establish the MV DC link. The one or more computing systems may receive a voltage feedback signal change from the output voltage V_{dcO} associated with the DAB to the AFE inner DC link V_{dc1}, V_{dc2}, . . . and V_{dcn} for the control system 400A. The output voltage V_{dcO} may be kept constant at the reference voltage value using external power supply (e.g., a battery). The external power supply may be current limited. The external current limited power-supply may comprise a pre-charge DC resistor and a bypass switch. The AFE inner DC link V_{dc1}, V_{dc2}, . . . and V_{dcn} may slowly ramp up to their reference value, while keeping the AFE disabled. Once the MV DC link reaches the voltage threshold and is operating at steady state, the grid connection is established.

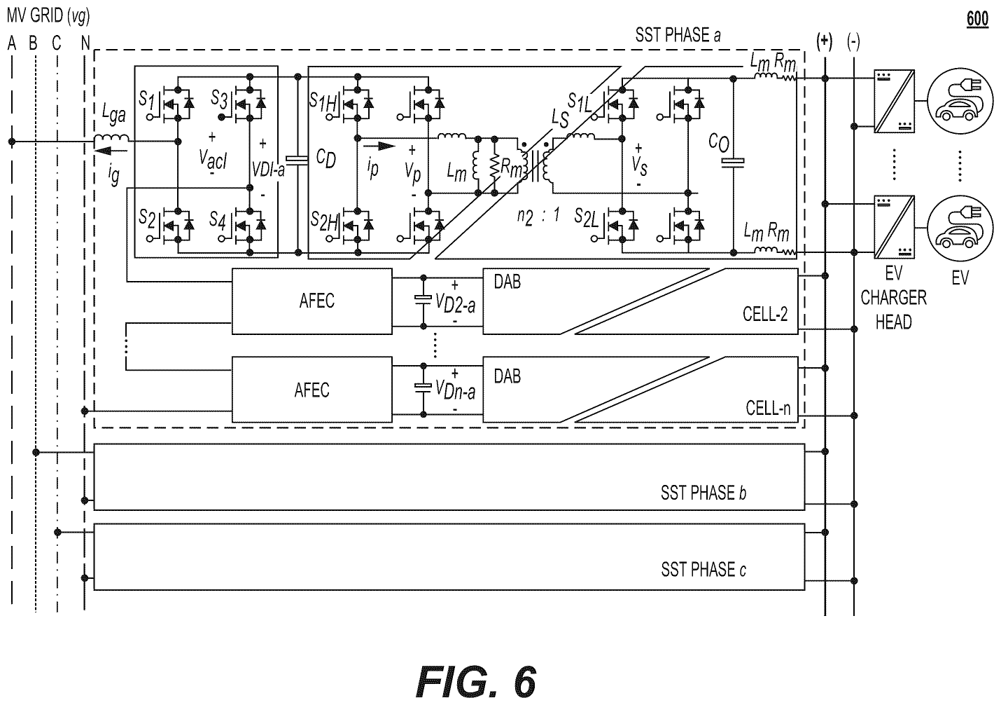

FIG. 6 illustrates an example three-phase AC/DC power converter system configuration. The AC/DC power converter system 100 may be expanded to a three-phase AC/DC power converter system 500. The three-phase AC/DC power converter system 500 may comprise N series connected AFE converters and N parallel connected DAB levels for SST phase a. Similarly, the three-phase AC/DC power converter system 500 may further comprise another N series connected AFE converters and N parallel connected DAB levels for each SST phase b and SST phase c. The control system 400A and/or the DAB control system 400B may be used for each level for the AFE and DAB converters for each SST phase a, SST phase b, and SST phase c.

In particular embodiments, the one or more computing systems may enable the DAB converter 130 to ramp up under the triple-phase shift (TPS) modulation, which may utilize a unified three degree of freedom control for optimizing the efficiency of different operating zones and modes of the DAB. The primary and secondary converters of the DAB may generate three-level switched voltage waveforms using three degree of freedom control variables. The one or more computing systems may independently regulate the duty ratios of the two full bridges and the phase shift ratio to generate the three-level voltage waveforms. The voltage turn-ons may be aligned and the secondary voltage may be turned off when the inductor current equals zero, where the secondary H-bridge may switch under zero current switching (ZCS). In particular embodiments, the one or more computing systems may detect the current has reached a highest peak value and may automatically switch from the TPS modulation to extended-phase shift (EPS) modulation to remove the current offset in the transformer current based on the detection of the current has reached the highest peak value, where the secondary H-Bridge for each DAB converters may be switch to a 50% duty cycle. In particular embodiments, the one or more computing systems may detect the output voltage of the DAB converters AC/DC power converter system 100 has reached a steady state, and automatically switch from the EPS modulation to a single-phase shift (SPS) modulation, which may use one degree of control freedom to regulate the output power flow of the DAB. As an example not by way of limitation, the switch pairs in both full bridges are gated to obtain phase shifted square waveforms with a 50% duty cycle ratio, and the phase shift angle φ among the bridges is controlled. Adjusting the phase shift angle φ between the primary and the secondary voltage results in the leakage inductor of the transformer changing to enable power flow direction and magnitude.

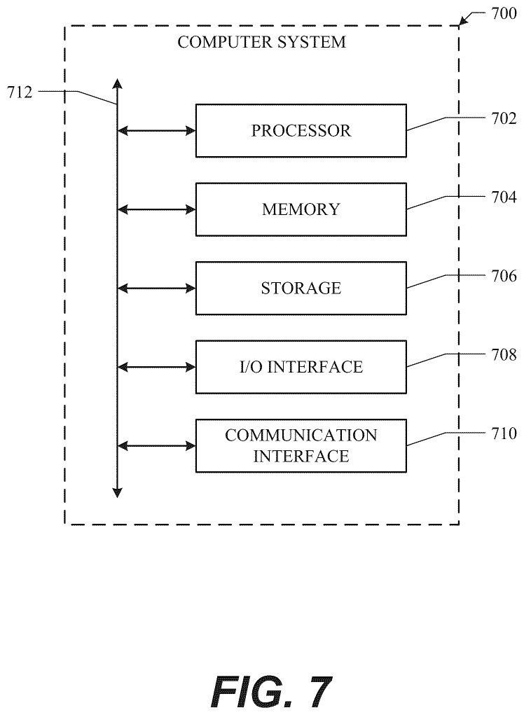

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more VAS computer systems 700. Herein, reference to a computer system can encompass a computing device, and vice versa, where appropriate. Moreover, reference to a computer system can encompass one or more computer systems, where appropriate.

This disclosure contemplates any suitable number of computer systems 700. This disclosure contemplates computer system 700 taking any suitable physical form. As example and not by way of limitation, computer system 700 can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 can include one or more computer systems 700; be unitary or distributed; span multiple locations; span multiple machines; span multiple data centers; or reside in a cloud, which can include one or more cloud components in one or more networks. Where appropriate, one or more computer systems 700 can perform without substantial spatial or temporal limitation one or more steps of one or more methods described or illustrated herein. As an example and not by way of limitation, one or more computer systems 700 can perform in real time or in batch mode one or more steps of one or more methods described or illustrated herein. One or more computer systems 700 can perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 can retrieve (or fetch) the instructions from an internal register, an internal cache, memory 704, or storage 706; decode and execute them; and then write one or more results to an internal register, an internal cache, memory 704, or storage 706. In particular embodiments, processor 702 can include one or more internal caches for data, instructions, or addresses. This disclosure contemplates processor 702 including any suitable number of any suitable internal caches, where appropriate. As an example and not by way of limitation, processor 702 can include one or more instruction caches, one or more data caches, and one or more translation lookaside buffers (TLBs). Instructions in the instruction caches can be copies of instructions in memory 704 or storage 706, and the instruction caches can speed up retrieval of those instructions by processor 702. Data in the data caches can be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches can speed up read or write operations by processor 702. The TLBs can speed up virtual-address translation for processor 702. In particular embodiments, processor 702 can include one or more internal registers for data, instructions, or addresses. This disclosure contemplates processor 702 including any suitable number of any suitable internal registers, where appropriate. Where appropriate, processor 702 can include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 can load instructions from storage 706 or another source (such as, for example, another computer system 700) to memory 704. Processor 702 can then load the instructions from memory 704 to an internal register or internal cache. To execute the instructions, processor 702 can retrieve the instructions from the internal register or internal cache and decode them. During or after execution of the instructions, processor 702 can write one or more results (which can be intermediate or final results) to the internal register or internal cache. Processor 702 can then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory bus (which can each include an address bus and a data bus) can couple processor 702 to memory 704. Bus 712 can include one or more memory bus, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 704 can include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 can include a hard disk drive (HDD), a floppy disk drive, flash memory, an optical disc, a magneto-optical disc, magnetic tape, or a Universal Serial Bus (USB) drive or a combination of two or more of these. Storage 706 can include removable or non-removable (or fixed) media, where appropriate. Storage 706 can be internal or external to computer system 700, where appropriate. In particular embodiments, storage 706 is non-volatile, solid-state memory. In particular embodiments, storage 706 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 can include one or more storage control units facilitating communication between processor 702 and storage 706, where appropriate. Where appropriate, storage 706 can include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 can include one or more of these I/O devices, where appropriate. One or more of these I/O devices can enable communication between a person and computer system 700. As an example and not by way of limitation, an I/O device can include a keyboard, keypad, microphone, monitor, mouse, printer, scanner, speaker, still camera, stylus, tablet, touch screen, trackball, video camera, another suitable I/O device or a combination of two or more of these. An I/O device can include one or more sensors. This disclosure contemplates any suitable I/O devices and any suitable I/O interfaces 708 for them. Where appropriate, I/O interface 708 can include one or more device or software drivers enabling processor 702 to drive one or more of these I/O devices. I/O interface 708 can include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 700 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 can include any suitable communication interface 710 for any of these networks, where appropriate. Communication interface 710 can include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 can include one or more bus 712, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method implemented by a computer system, comprising:
receiving DC bus voltage conditions of a plurality of AC to DC converters of an Input-Series-Output-Parallel (ISOP) power converter during a rectification stage for pre-charging DC bus of the plurality of AC to DC converters;
detecting (1) a peak voltage of each of the DC bus of the plurality of AC to DC converters during the rectification stage has reached a first threshold voltage, and (2) that a Phase Loop Lock (PLL) signal indicates a locked state with an AC grid voltage;
upon detecting that the PLL signal indicates the locked state with the AC grid voltage, enabling a first voltage regulation to charge an AC to DC output of each of the plurality of AC to DC converters to reach a first reference voltage;
determining an operating condition of the ISOP power converter, wherein the operating condition comprises (1) a load condition and an output voltage condition associated with a plurality of Dual Active Bridge (DAB) converters, and (2) a monitored voltage condition of each of the plurality of AC to DC converters;
enabling a second voltage regulation of each of the plurality of DAB converters to charge a DAB output to reach a second reference voltage within a current limit based on the operating condition; and
maintaining the second reference voltage for the output voltage condition.

2. The method of claim 1, further comprising:
generating control variables for the second voltage regulation based on the operation condition, wherein the control variables comprise a first pulse width of a primary H-Bridge output voltage for each of the DAB converters, a second pulse width of a secondary H-Bridge output voltage for each of the DAB converters, and a phase shift angle between the primary H-Bridge output voltage and the secondary H-Bridge output voltage; and
enabling the second voltage regulation of each of the plurality of DAB converters to reach the second reference voltage within the current limit based on the control variables.

3. The method of claim 1, further comprising:
pre-charging the DC bus of the plurality of AC to DC converters with a power source connected to an output of the DAB converters; and
enabling a reverse charging voltage regulation of each of the plurality of AC to DC converters being within the current limit based on the control variables.

4. The method of claim 1, wherein the load condition comprises a no-load condition and a partial load condition.

5. The method of claim 1, wherein the output voltage condition comprises a zero-output voltage condition and a partial output voltage condition.

6. The method of claim 5, further comprising:
monitoring an initial voltage value associated with the partial output voltage condition.

7. The method of claim 1, wherein the monitored voltage condition of each of the plurality of AC to DC converters comprises the monitored voltage condition of the AC to DC output of each of the plurality of AC to DC converters has reached the first reference voltage, and the monitored voltage condition of the AC to DC output of each of the plurality of AC to DC converters has reached the peak voltage while the PLL signal indicates the locked state with the AC grid voltage.

8. The method of claim 7, further comprising:
simultaneously enabling the second voltage regulation of each of the plurality of DAB converters to charge the DAB output to reach the second reference voltage when detecting the monitored voltage condition of each of the plurality of AC to DC converters has reached the first reference voltage.

9. The method of claim 7, further comprising:
simultaneously enabling the second voltage regulation of each of the plurality of DAB converters to charge the DAB output to reach the second reference voltage when detecting the monitored voltage condition of each of the plurality of AC to DC converters has reached the peak voltage while the PLL signal indicates the locked state with the AC grid voltage.

10. The method of claim 1, wherein the maintaining the second reference voltage for the output voltage condition comprises at least one of enabling an AC to DC voltage regulation, or enabling a DC to DC voltage regulation.

11. The method of claim 1, wherein the rectification stage for pre-charging DC bus of the plurality of AC to DC converters is enabled via a pre-charge switch system, wherein the pre-change switch system comprises a first switch and a resistor for reducing an inrush current, and a bypass second switch that operates when the peak voltage of each of the DC bus of plurality of AC to DC converters during the rectification stage has reached the first threshold voltage.

12. A system comprising: one or more processors; and a non-transitory memory coupled to the processors comprising instructions executable by the processors, the processors operable when executing the instructions to:
receive DC bus voltage conditions of a plurality of AC to DC converters of an Input-Series-Output-Parallel (ISOP) power converter during a rectification stage for pre-charging DC bus of the plurality of AC to DC converters;
detect (1) a peak voltage of each of the DC bus of the plurality of AC to DC converters during the rectification stage has reached a first threshold voltage, and (2) that a Phase Loop Lock (PLL) signal indicates a locked state with an AC gird voltage;
upon detecting that the PLL signal indicates the locked state with the AC gird voltage, enable a first voltage regulation to charge an AC to DC output of each of the plurality of AC to DC converters to reach a first reference voltage;
determine an operating condition of the ISOP power converter, wherein the operating condition comprises (1) a load condition and an output voltage condition associated with a plurality of Dual Active Bridge (DAB) converters, and (2) a monitored voltage condition of each of the plurality of AC to DC converters;
enable a second voltage regulation of each of the plurality of DAB converters to charge a DAB output to reach a second reference voltage within a current limit based on the operating condition; and
maintain the second reference voltage for the output voltage condition.

13. The system of claim 12, wherein the processors are further operable when executing the instructions to:
generate control variables for the second voltage regulation based on the operation condition, wherein the control variables comprise a first pulse width of a primary H-Bridge output voltage for each of the DAB converters, a second pulse width of a secondary H-Bridge output voltage for each of the DAB converters, and a phase shift angle between the primary H-Bridge output voltage and the secondary H-Bridge output voltage; and
enable the second voltage regulation of each of the plurality of DAB converters to reach the second reference voltage within the current limit based on the control variables.

14. The system of claim 12, wherein the processors are further operable when executing the instructions to:
pre-charge the DC bus of the plurality of AC to DC converters with a power source connected to an output of the DAB converters; and
enable a reverse charging voltage regulation of each of the plurality of AC to DC converters being within the current limit based on the control variables.

15. The system of claim 12, wherein the load condition comprises a no-load condition and a partial load condition.

16. The system of claim 12, wherein the output voltage condition comprises a zero-output voltage condition and a partial output voltage condition.

17. The system of claim 12, wherein the monitored voltage condition of each of the plurality of AC to DC converters comprises the monitored voltage condition of the AC to DC output of each of the plurality of AC to DC converters has reached the first reference voltage, and the monitored voltage condition of the AC to DC output of each of the plurality of AC to DC converters has reached the peak voltage while the PLL signal indicates the locked state with the AC gird voltage.

18. The system of claim 17, wherein the processors are further operable when executing the instructions to:
simultaneously enable the second voltage regulation of each of the plurality of DAB converters to charge the DAB output to reach the second reference voltage when detecting the monitored voltage condition of each of the plurality of AC to DC converters has reached the first reference voltage.

19. The system of claim 17, wherein the processors are further operable when executing the instructions to:
simultaneously enable the second voltage regulation of each of the plurality of DAB converters to charge the DAB output to reach the second reference voltage when detecting the monitored voltage condition of each of the plurality of AC to DC converters has reached the peak voltage while the PLL signal indicates the locked state with the AC gird voltage.

20. One or more computer-readable non-transitory storage media embodying software that is operable when executed to:
receive DC bus voltage conditions of a plurality of AC to DC converters of an Input-Series-Output-Parallel (ISOP) power converter during a rectification stage for pre-charging DC bus of the plurality of AC to DC converters;
detect (1) a peak voltage of each of the DC bus of the plurality of AC to DC converters during the rectification stage has reached a first threshold voltage, and (2) that a Phase Loop Lock (PLL) signal indicates a locked state with an AC grid voltage;
upon detecting that the PLL signal indicates the locked state with the AC gird voltage, enable a first voltage regulation to charge an AC to DC output of each of the plurality of AC to DC converters to reach a first reference voltage;
determine an operating condition of the ISOP power converter, wherein the operating condition comprises (1) a load condition and an output voltage condition associated with a plurality of Dual Active Bridge (DAB) converters, and (2) a monitored voltage condition of each of the plurality of AC to DC converters;
enable a second voltage regulation of each of the plurality of DAB converters to charge a DAB output to reach a second reference voltage within a current limit based on the operating condition; and
maintain the second reference voltage for the output voltage condition.
